(19) United States
(12) Patent Application Publication
(10) Pub. No.: US 2016/0108806 A1
(43) Pub. Date: Apr. 21, 2016

(54) TWO SPEED BELT DRIVE SYSTEM

(71) Applicant: THE GATES CORPORATION, DENVER, CO (US)

(72) Inventors: Alexander Serkh, Troy, MI (US); Dean Schneider, Washington, MI (US)

(21) Appl. No.: 14/515,114

(22) Filed: Oct. 15, 2014

(51) Int. Cl. F02B 67/06; F16H 9/06

(52) U.S. Cl. CPC F02B 67/06; F16H 9/06

(57) ABSTRACT

A two speed belt drive system comprising a crankshaft module (200) comprising a first pulley (213) engaging a first belt (10) and a second pulley (206) engaging a second belt (20), a clutch module (100) engaging the first belt and the second belt, the second belt (20) engaged to an engine accessory, the crankshaft module having a clutch spring (205) for frictional driving of the second pulley, and the clutch module having a clutch (57) for selectively driving the second belt.

### FIELD OF THE INVENTION

The invention relates to a two speed belt drive system comprising a crankshaft module comprising a first pulley engaging a first belt and a second pulley engaging a second belt, a clutch module engaging the first belt and the second belt, the second belt engaged to an engine accessory, the crankshaft module having a clutch spring for frictional driving of the second pulley, and the clutch module having a clutch for selectively driving the second belt.

### BACKGROUND OF THE INVENTION

This invention relates to automotive accessory belt drive systems (ABDS drives).

Representative of the art is U.S. Pat. No. 7,798,928 which discloses a dual ratio belt drive system comprising a clutch unit mounted directly to a driver rotating shaft, a one-way clutch mounted directly to the driver rotating shaft, a plurality of rotating accessories rotatably connected to the clutch unit and rotatably connected to the driver rotating shaft through the one-way clutch such that the accessories are driven by the clutch unit at a first speed ratio and driven directly by the driver rotating shaft through said one-way clutch at a second speed ratio, with the clutch unit operating at a predetermined value of an engine operating condition thereby defining the transition between the first and second speed ratios, and the clutch unit being engaged at engine start.

What is needed is a two speed belt drive system comprising a crankshaft module comprising a first pulley engaging a first belt and a second pulley engaging a second belt, a clutch module engaging the first belt and the second belt, the second belt engaged to an engine accessory, the crankshaft module having a clutch spring for frictional driving of the second pulley, and the clutch module having a clutch for selectively driving the second belt. The present invention meets this need.

### SUMMARY OF THE INVENTION

The primary aspect of the invention is a two speed belt drive system comprising a crankshaft module comprising a first pulley engaging a first belt and a second pulley engaging a second belt, a clutch module engaging the first belt and the second belt, the second belt engaged to an engine accessory, the crankshaft module having a clutch spring for frictional driving of the second pulley, and the clutch module having a clutch for selectively driving the second belt.

Other aspects of the invention will be pointed out or made obvious by the following description of the invention and the accompanying drawings.

The invention comprises a two speed belt drive system comprising a crankshaft module comprising a first pulley engaging a first belt and a second pulley engaging a second belt, a clutch module engaging the first belt and the second belt, the second belt engaged to an engine accessory, the crankshaft module having a clutch spring for frictional driving of the second pulley, and the clutch module having a clutch for selectively driving the second belt.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a front view of a belt drive system.

FIG. 2A is a front view of the crankshaft module.

FIG. 2B is a rear view of the crankshaft module.

FIG. 3 is a cross-sectional view of the crankshaft module.

FIG. 4 is an exploded view of the crankshaft module.

FIG. 5 is a rear view of the crankshaft damper assembly.

FIG. 6 is a side view of the isolating spring.

FIG. 7A is a front view of the spring carrier.

FIG. 7B is a rear view of the spring carrier.

FIG. 8 is a front view of the clutch spring.

FIG. 9 is a front view of the pulley.

FIG. 10 is a cross-sectional view of the secondary clutch module.

FIG. 11 is a chart of system operation.

### DETAILED DESCRIPTION OF THE PREFERRED EMBODIMENT

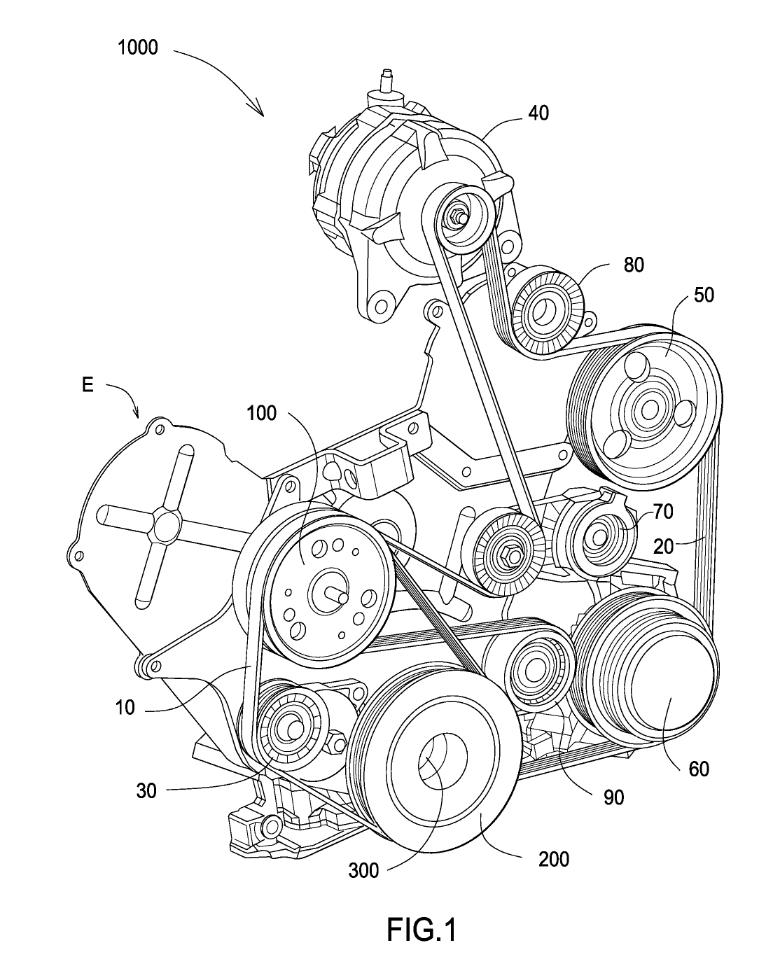

FIG. 1 is a front view of a belt drive system. System 1000 comprises a front-end accessory drive for an internal combustion engine (E). In FIG. 1 the front of the engine is shown and the rest is omitted for clarity.

The inventive system 1000 comprises a belt 10 and a second belt 20. Various engine and vehicle accessory components are driven by belt 20. Belt 10 and belt 20 are each a multi-ribbed belt. This means the ribs extend in parallel along the endless direction of the belt.

Belt 10 is only entrained about clutch module 100, crankshaft module 200 and tensioner 30. Belt 10 transmits power from crankshaft module 200 to clutch module 100. Belt 20 is entrained about crankshaft module 200, clutch module 100 and the accessories including the alternator 40, power steering pump 50 and water pump 60. Belt 20 also engages tensioner 70, idler 80 and idler 90. Tensioner 70 maintains proper load in belt 20.

Tensioner 30 maintains proper belt load in belt 10. Tensioner 70 and tensioner 30 are each known in the art. Proper belt load prevents belt slip and noise.

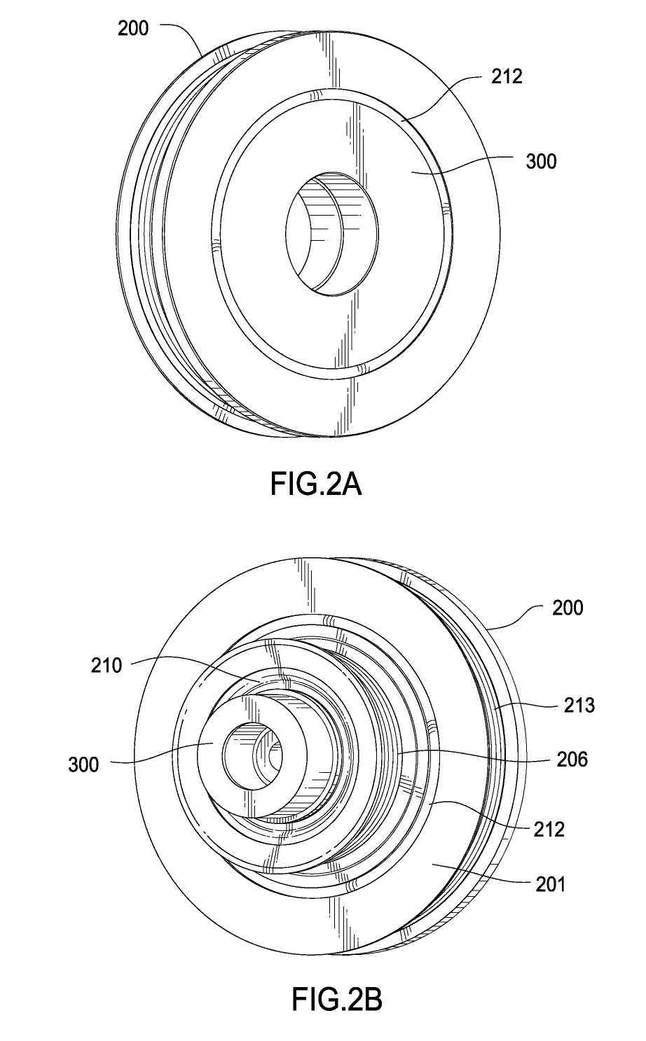

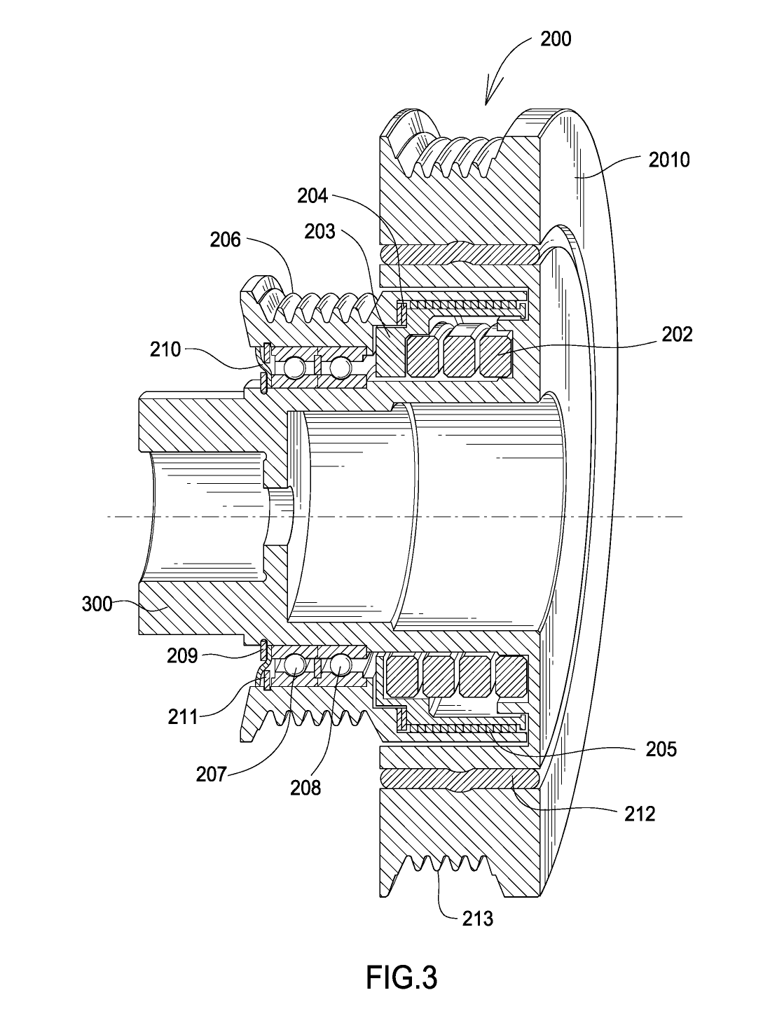

FIG. 2A is a front view of the crankshaft module. FIG. 2B is a rear view of the crankshaft module. FIG. 3 is a cross-sectional view of the crankshaft module. Referring to FIG. 3, crankshaft module 200 comprises damper assembly 201, hub 300, isolating spring 202, spring carrier 203, bushing 204A, bushing 204B, clutch spring 205, pulley 206, bearing 207, bearing 208, retainer 209, shield 210, retainer 211. Damper assembly 201 comprises inertia member 2010 and elastomeric member 212. Elastomeric member 212 comprises a resilient material which allows slight incremental oscillatory movement of inertia member 2010 relative to hub 300, which in turn damps crankshaft oscillations caused by cylinder firing events. Isolating spring 202 is loaded in the unwinding direction. Shield 210 prevents debris from entering the device.

Inertia member 2010 further comprises pulley 213. Pulley 213 and pulley 206 engage belt 10 and belt 20 respectively. Hub 300 comprises spring receiving portion 301 and spring stop 302. An end 2020 of isolating spring 202 engages stop 302. Isolating spring 202 is nested within spring receiving portion 301. Hub 300 is rigidly connected to an engine crankshaft.

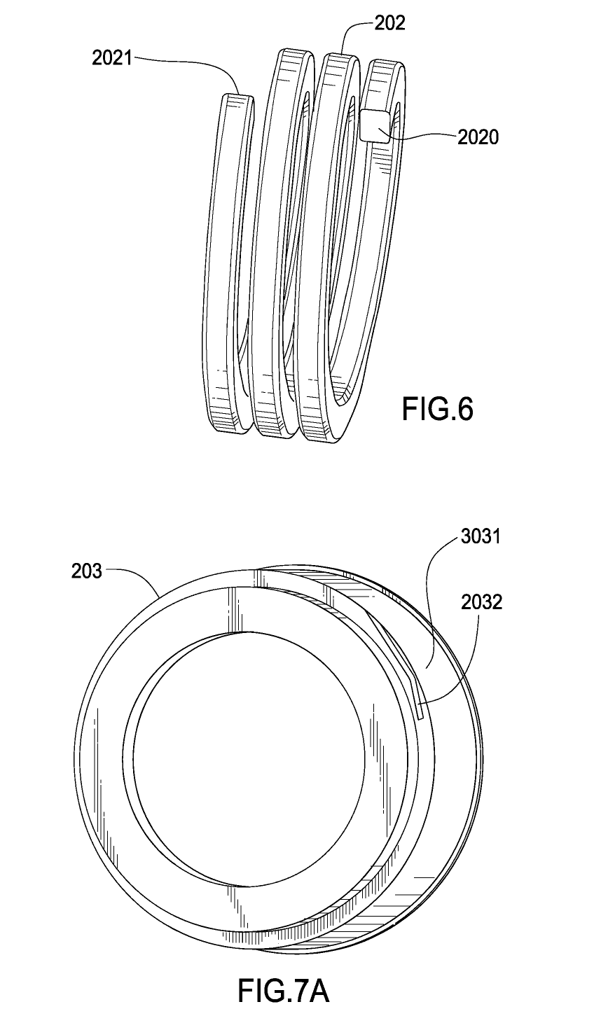

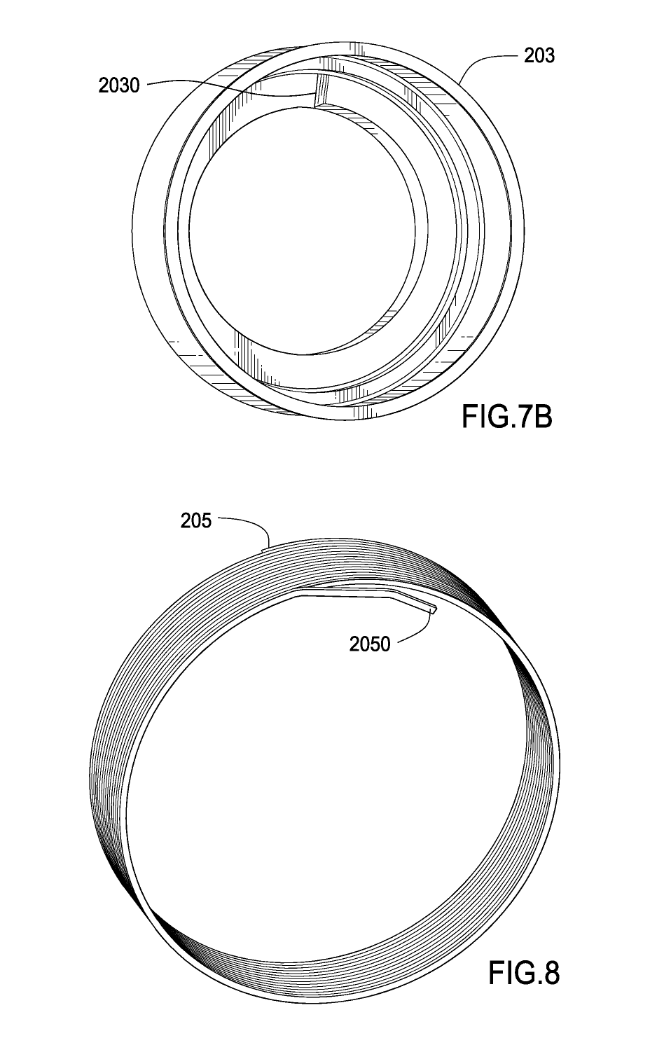

FIG. 6 is a side view of the isolating spring. Isolating spring 202 engages spring carrier 203. End 2021 of spring 202 engages stop 2030, see FIG. 7B. Spring carrier 203 further comprises outer cylindrical surface 2031. Clutch spring 205 frictionally engages surface 2031.

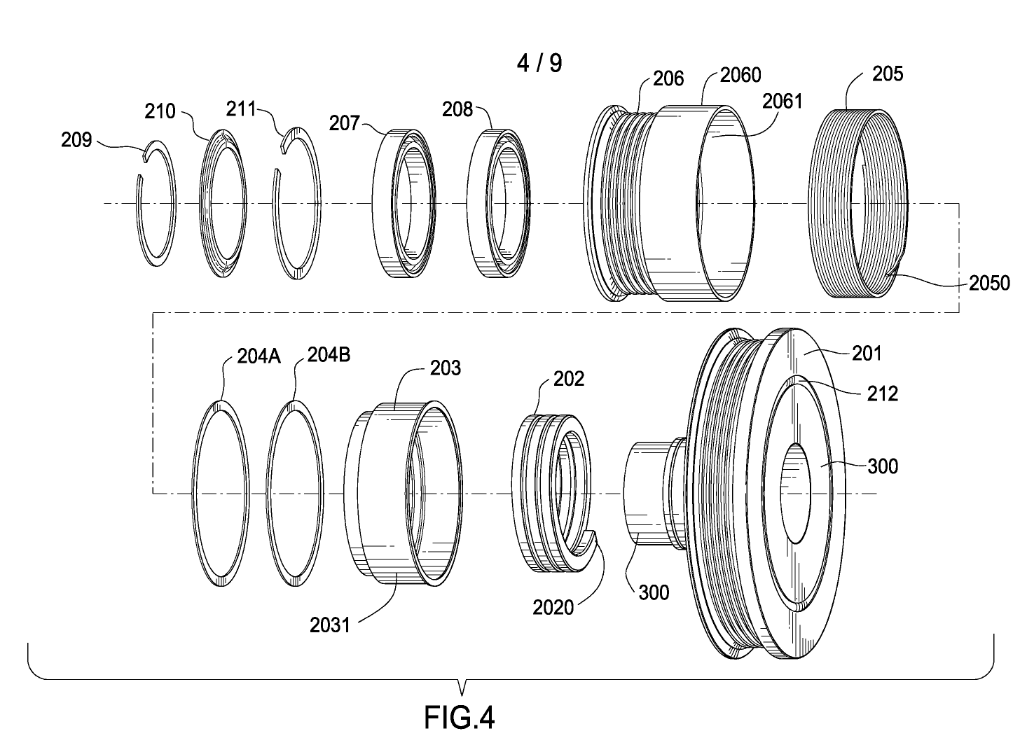

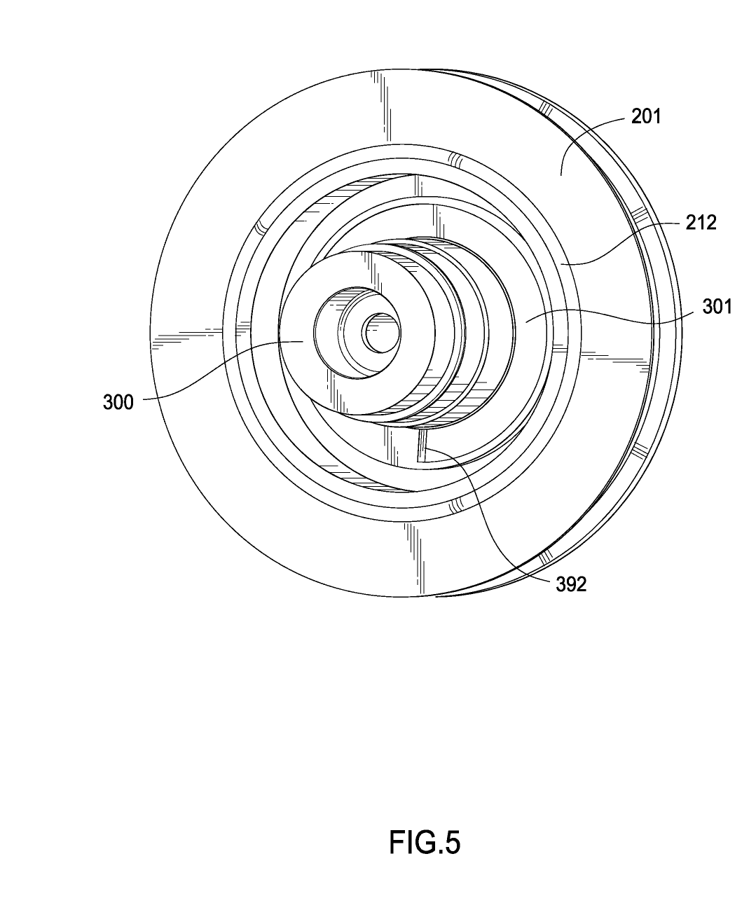

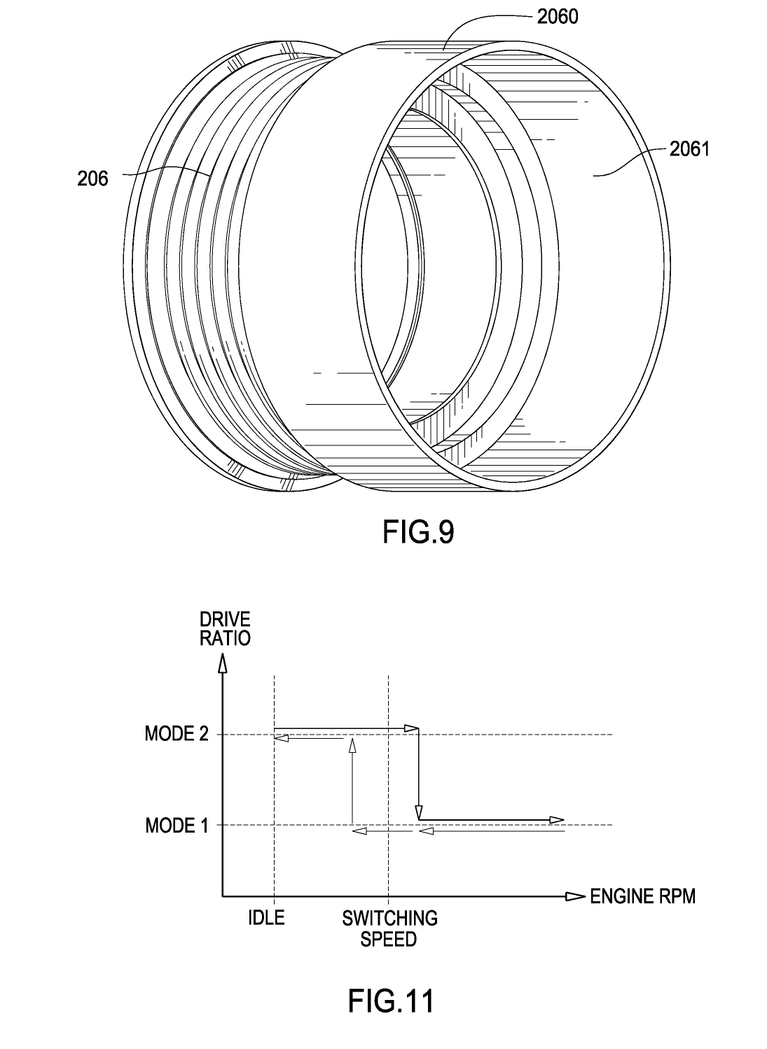

End 2050 of spring 205 engages receiving portion 2032, see FIG. 7A. Pulley 206 comprises inner surface 2061 and outer surface 2060, see FIG. 9. Clutch spring 205 frictionally engages inner surface 2061. FIG. 4 is an exploded view of the crankshaft module.

In operation hub 300 drives isolating spring 202 in an unwinding direction. End 2020 of spring 202 engages stop 302. Spring 202 in turn drives spring carrier 203. Spring carrier 203 drives clutch spring 205 in an unwinding direction. This causes clutch spring 205 to radially expand against surface 2061, which causes spring 205 to frictionally engage and drive pulley 206. When clutched in this manner, pulley 206 rotates at the same speed as hub 300. Pulley 213 also rotates at the same speed as pulley 206 in this mode.

When clutch spring 205 is not driving pulley 206, spring 205 radially contracts thereby disengaging from surface 2061. Pulley 206 can then overrun and rotate faster than hub 300. This condition occurs during engine deceleration for example, when the belt drive system inertia prevents deceleration of the belt drive system at the same rate as the engine. Each of the accessories, such as the alternator, has an inertia. The inertia may prevent the accessory from decelerating as quickly as the engine, at which point it is said to overrun the engine.

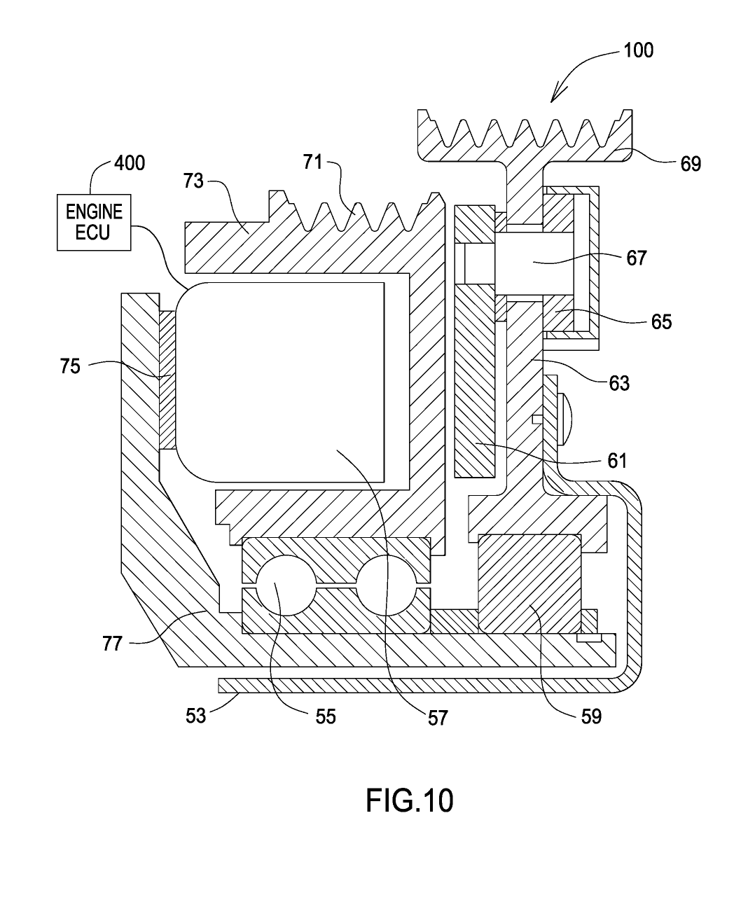

Clutch module 100 is described in U.S. Pat. No. 7,798,928, for example see FIG. 9. U.S. Pat. No. 7,798,928 is incorporated herein in its entirety by reference. FIG. 10 is a cross-sectional view of the clutch module 100. FIG. 10 depicts the upper half of a cross-sectional view, the lower half being a mirror image and symmetric with the upper half. Clutch module 100 comprises an electromagnetic clutch with coil 57. Coil 57 is attached to a stationary housing 77 thru back plate 75. Housing 77 does not rotate and is used to mount the clutch to a surface, for example, an engine surface. Rotor 73 with pulley 71 is rotatably installed on ball bearing 55 on housing 77. Bearing 55 comprises a ball bearing but may also comprise any suitable bearing known in the art. Clutch plate 61 is moveably attached to second pulley 69 with shafts 67, for example, three shafts 67 symmetrically spaced about pulley 69. Rubber pads 65 bias plate 61 away from rotor 73 when coil 57 is not energized. This method of attachment allows plate 61 to move axially from pulley 69 towards rotor 73 when the coil 57 is energized and the clutch is thereby engaged. Pulley 69 also comprises hub 53 by which pulley 69 is directly connected to an accessory, such as a power steering pump shaft. Coil 57 is contained within a width of pulley 71 and plate 61 is contained within a width of pulley 69. Coil 57 is connected to an engine ECU system 400, known in the art, whereby engine speed signals can be used to control and thereby activate or deactivate coil 57 according to the switching speed. Coil 57 is connected to the vehicle electrical system, known in the art.

The inventive system comprises two operating modes. In operating Mode 1, secondary clutch module 100 is open or released, namely, electromagnetic clutch coil 57 is de-energized. As a result pulley 206 acts as the driver for the belt drive system through belt 20. The speed of the belt drive is a function of the diameter of pulley 206. Pulley 206 rotates at the same RPM speed as the engine crankshaft. This is typical during off-idle conditions.

Power from the engine crankshaft flows from hub 300 through stop 302 to isolating spring 202, then to spring carrier 203, then to cutch spring 207 and then to pulley 206 and on to belt 20. Pulley 213 drives belt 10, which engages secondary clutch module 100.

Crankshaft torsional vibrations are isolated from pulley 206 through operation of isolating spring 202.

Spring 202 has a torsional spring rate, which allows torsional load vibrations to be absorbed by the spring 202. Since the crankshaft torsional vibrations are thereby isolated from pulley 206, the vibrations are also isolated from the belt drive system.

In operating Mode 2, secondary clutch module 100 is closed or locked, that is, the electromagnetic clutch coil is activated which locks pulley 69 to pulley 71. In this mode pulley 213 is the driver for the belt drive system. The speed of the drive is a function of the diameter of pulley 213. Pulley 213 has a greater diameter than pulley 206. Pulley 213 drives belt 10. Belt 10 drives the secondary clutch module 100. Secondary clutch module then drives belt 20. Due to the difference in diameter between pulley 213, pulley 206 and the secondary clutch module 100, the speed of belt 20 is increased and pulley 206 rotates faster than the engine crankshaft. Pulley 206 is said to “overrun” the hub 300 (crankshaft). Clutch spring 205 is disengaged from surface 2061 in the overrun condition and is considered “open”. Mode 2 is used when the engine speed is low, such as at idle. An increase in belt speed allows engine idle speed to be decreased allowing the belt to maintain proper speed for the alternator and air conditioning compressor, for example. A lower engine idle speed reduces fuel consumption.

FIG. 11 is a chart which provides an example of how the system operates. The clutch module drive ratio versus engine speed is illustrated. The drive ratio is the ratio between pulley 206 and pulley 71.

The desired switching speed centers a speed zone where the system may operate in either mode. The speed zone range serves to limit repeated switching between modes as the engine speed varies around the switching speed, for example, in a range of approximately 200 RPM. At idle the accessory drive is in mode 2 and clutch 57 is engaged, thereby driving belt 20 with pulley 71. Pulley 206 is in an overrun condition in mode 2, with spring 205 disengaged.

As engine speed increases and approaches the desired switching speed, clutch module 100 switches from mode 2 to mode 1 when clutch 57 de-energizes and disengages. The accessories are driven by pulley 206 in mode 1. Use of pulley 206 reduces the overall accessory speed because it has a smaller diameter than pulley 71. As engine speed decreases below the switching speed, clutch module clutch 57 engages, thereby switching from mode 1 to mode 2, which in turn increases overall accessory speed in mode 2 and during idle.

For example if the switching speed is 1200 rpm, when the system is in mode 2, the switch from mode 2 to mode 1 occurs approximately 100 rpm above the switching speed as engine speed increases. Conversely, when the system is in mode 1, the switch from mode 1 to mode 2 occurs approximately 100 rpm below the switching speed as engine speed decreases.

In a typical situation, engine idle speed can be reduced by 50 to 100 RPM by use of the inventive system. For example, a typical engine idle speed can be approximately 600 RPM.

TABLE 1

| | Size | Speed Mode | Speed Mode |
|---|---|---|---|
| Pulley | (mm) | 1 (RPM) | 2 (RPM) |
| 213 Crankshaft | 147.8 | 1200 | 1200 |
| 206 Crankshaft | 88.0 | 1200 | 1831 |
| 69 Clutch module | 127.1 | 1395 | 1395 |
| 71 Clutch module | 115.5 | 914.3 | 1395 |
| Belt 20 speed (m/s) | | 5.52 | 8.44 |

By way of example and not of limitation, Table 1 illustrates a set of example design parameters for the system.

Mode 2 allows accessories to operate at a speed that enables them to function properly and efficiently at lower engines speeds, for example, 50 RPM to 100 RPM below a typical idle speed, for example, 600 RPM. Mode 1 slows the accessories but still allows accessories to operate at a speed that enables them to function properly and efficiently for off-idle engine speeds above the switching speed. Slowing the accessories reduces overall fuel consumption and vehicle emissions, improves the efficiency of the accessories, and improves vehicle acceleration performance. Speeding up the accessories at idle allows for overall reduction of engine idle speed which reduces fuel consumption and vehicle emissions.

Although forms of the invention have been described herein, it will be obvious to those skilled in the art that variations may be made in the construction and relation of parts without departing from the spirit and scope of the invention described herein.

1. A two speed belt drive system comprising:
a crankshaft module (200) comprising a first pulley (213) engaging a first belt (10) and a second pulley (206) engaging a second belt (20);
a clutch module (100) engaging the first belt and the second belt;
the second belt (20) engaged to an engine accessory;
the crankshaft module having a clutch spring (205) for frictional driving of the second pulley; and
the clutch module having a clutch (57) for selectively driving the second belt.

2. The system as in claim 1, wherein the clutch module comprises an electromagnetic clutch.

3. The system as in claim 1, wherein the crankshaft module clutch spring is loaded in the unwinding direction.

4. The system as in claim 1, wherein the crankshaft module comprises an inertia member mounted thereto by an elastomeric member.

5. The system as in claim 1, wherein the clutch module clutch is engaged during an engine idle condition.

6. The system as in claim 1, wherein the clutch module clutch is disengaged during an engine off-idle condition.

7. The system as in claim 1 further comprising a tensioner engaged with the first belt.

8. The system as in claim 1 further comprising a tensioner engaged with the second belt.

9. The system as in claim 1, wherein the clutch spring is disengaged during an overrun condition.

10. A two speed belt drive system comprising:
a crankshaft module (200) comprising a first pulley (213) engaging a first belt (10) and a second pulley (206) engaging a second belt (20), the crankshaft module further comprising an inertia member (2010) mounted thereto by an elastomeric member (212);
a clutch module (100) engaging the first belt and the second belt, the crankshaft module driving the clutch module with the first belt;
the second belt driving an engine accessory;
the crankshaft module having a clutch spring (205) for frictional driving of the second pulley, the clutch spring releasable during a predetermined condition; and
the clutch module having an electromagnetic clutch (57) for selectively driving the second belt during an engine idle condition at a speed that is greater than during an engine off-idle condition.

11. The system as in claim 10, wherein the electromagnetic clutch is disengaged during an engine off-idle condition.

12. The system as in claim 10 further comprising a tensioner engaged with the first belt.

13. The system as in claim 10 further comprising a tensioner engaged with the second belt.

14. A two speed belt drive system comprising:
a crankshaft module (200) comprising a first pulley (213) engaging a first belt (10) and a second pulley (206) engaging a second belt (20), the first pulley further comprising an inertia member (2010) mounted to a hub (300) by an elastomeric member (212);
a clutch module (100) engaging the first belt and the second belt, the crankshaft module driving the clutch module with the first belt;
the second belt driving an engine accessory;
the crankshaft module having a clutch spring (205) for frictional driving of the second pulley, the clutch spring releasable during an overrun condition; and
the clutch module having an electromagnetic clutch (57) for selectively driving the second belt during an engine idle condition at a speed that is greater than during an engine off-idle condition, the electromagnetic clutch is engaged during an engine idle condition.

15. The system as in claim 14 further comprising a tensioner engaged with the first belt.

16. The system as in claim 14 further comprising a tensioner engaged with the second belt.

17. The system as in claim 14, wherein the crankshaft module clutch spring is in a overrun condition when the electromagnetic clutch is engaged.
